(19) United States
(12) Patent Application Publication
(10) Pub. No.: US 2026/0249628 A1
(43) Pub. Date: Aug. 27, 2026

(54) PRINTER

(71) Applicant: Hiroyuki Taki, Mishima Shizuoka (JP)

(72) Inventor: Hiroyuki Taki, Mishima Shizuoka (JP)

(73) Assignee: ETRIA CO., LTD., Kanagawa (JP)

(21) Appl. No.: 19/276,263

(22) Filed: Jul. 22, 2025

(30) Foreign Application Priority Data
Feb. 21, 2025 (JP) 2025-026936

(51) Int. Cl. B41J 25/312; B41J 2/32; B41J 3/407; B41J 11/04

(52) U.S. Cl. CPC B41J 25/312; B41J 2/32; B41J 3/4075; B41J 11/04

(57) ABSTRACT

A printer includes a conveying unit, a printing unit, a pressing unit, a supporting unit and a setting unit. The conveying unit includes a platen roller extending in a first direction to convey the medium in a second direction orthogonal to the first direction through a conveying path. The printing unit is located opposite to the platen roller with the conveying path interposed therebetween to print an image on the medium. The pressing unit presses the printing unit in a third direction toward the platen roller. The supporting unit supports the pressing unit movably in the first direction. The setting unit sets a pressing force applied by the pressing unit in accordance with a position of the pressing unit such that a pressing force applied to the medium is uniformed along the first direction and a pressing force per unit length along the first direction is made constant.

### CROSS-REFERENCE TO RELATED APPLICATIONS

This application is based upon and claims the benefit of priority from Japanese Patent Application No.2025-026936, filed Feb. 21, 2025, the entire contents of which are incorporated herein by reference.

### FIELD

Embodiment described herein relate generally to a printer that prints images on a long sheet of label paper having a predetermined width.

### BACKGROUND

There is a prior art printer equipped with a platen roller that pulls a long sheet of label paper out of a roll and then carries it and a thermal head that presses the label paper on the platen roller to print an image. The thermal head has a length exceeding the width of the label paper.

There is a variety of label paper sheets having different widths, and the thermal head has a length capable of printing images on the label paper of the maximum width. If, therefore, an image is printed on a relatively narrow-width sheet of label paper, the thermal head easily comes into contact with the platen roller at a position away from the label paper, and the pressing force of the thermal head on the label paper tends to be uneven in the width direction, with the result that the print quality is easily degraded.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic view showing a printer according to an embodiment.

FIG. 2 is a perspective view showing an essential part of the printer of FIG. 1.

FIG. 3 is a perspective view showing a thermal head of FIG. 2 which is located in a retracted position.

FIG. 4 is a sectional view taken along line F4-F4 of the essential part of the thermal head of FIG. 2.

FIG. 5 is a perspective view showing the thermal head of FIG. 3 which is located at the printing position.

FIG. 6 is a schematic view showing a pressing member on the left side of FIG. 2 which is opposed to the second pressure-receiving surface from the left of a pressed block.

FIG. 7 is a schematic view showing the pressing member on the left side of FIG. 2 which is opposed to the third pressure-receiving surface from the left side of the pressed block.

FIG. 8 is a schematic view showing the pressing member on the left side of FIG. 2 which is opposed to the non-contact surface of the pressed block.

FIG. 9 is a partially enlarged view showing an essential part of the pressing member of FIG. 8.

FIG. 10 is a graph illustrating an advantage of the embodiment.

FIG. 11 is a graph illustrating an advantage of the embodiment.

FIG. 12 is a schematic view showing an essential part of a printer according to a modification of the embodiment.

### DETAILED DESCRIPTION

According to one embodiment, a printer includes a conveying unit, a printing unit, a pressing unit, a supporting unit and a setting unit. The conveying unit includes a platen roller extending in a first direction across a conveying path of a medium to be printed with an image to convey the medium to be printed in a second direction orthogonal to the first direction through the conveying path. The printing unit is located opposite to the platen roller with the conveying path interposed therebetween to print an image on the medium to be printed conveyed through the conveying path. The pressing unit presses the printing unit in a third direction toward the platen roller. The supporting unit supports the pressing unit movably in the first direction in accordance with a width of the medium to be printed along the first direction. The setting unit sets a pressing force applied by the pressing unit in accordance with a position of the pressing unit in the first direction such that a pressing force applied to the medium to be printed by the platen roller and the printing unit is uniformed along the first direction and a pressing force per unit length along the first direction is made constant regardless of the width of the medium to be printed.

The printer 100 according to one embodiment will be described below with reference to the drawings.

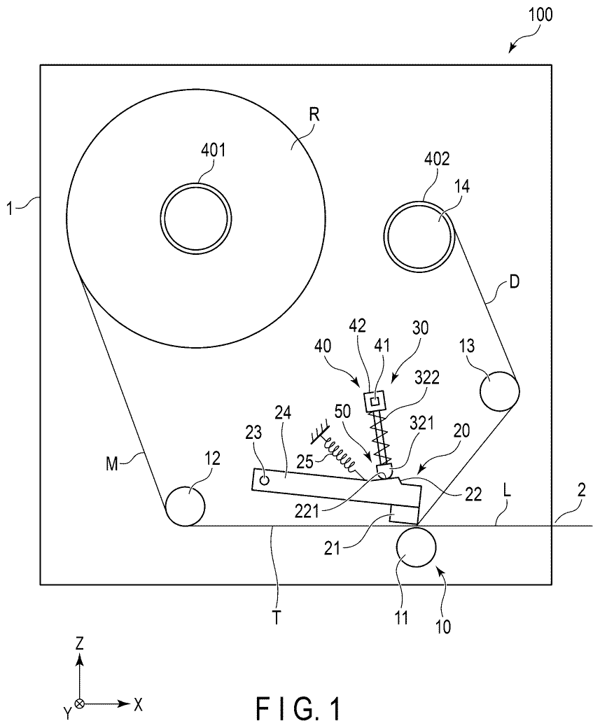

As shown in FIG. 1, the printer 100 includes a substantially rectangular box-shaped housing 1 which forms an outer shell of the printer. The housing 1 includes a discharge port 2 that discharges a label L (a medium for printing) on which an image is printed and an open/close cover (not shown) for inserting a roll R of label paper M. A frame (not shown) is fixed to the interior of the housing 1 to attach each mechanism of the printer 100. In the following description, the frame is regarded as part of the housing 1.

In the following description, the side of the housing 1, which is close to the discharge port 2, is defined as a front side, and the front and rear, right and left, and up and down directions are defined when the printer 100 is viewed from the front side. In each of the drawings, a direction from the rear to the front is indicated by arrow X, a direction from the left to the right is indicated by arrow Y, and a direction from the bottom to the top is indicated by arrow Z. The first direction in the claims corresponds to the Y direction, the second direction generally corresponds to the X direction, and the third direction generally corresponds to the Z direction.

The housing 1 of the printer 100 houses a roll R with a core material 401 on which a long strip of label paper M is wound. The roll R is attached to the interior of the housing 1 in a direction such that it rotates counterclockwise in FIG. 1 when the label paper M is pulled out. The label paper M is, for example, formed by sticking a plurality of labels L side by side on one surface of a long mount D. The labels L each have an adhesive layer alongside the one surface of the mount D. The labels L are detachable from the mount D, and can be attached to other articles after peeled off from the mount D. In addition, the labels L develop color by heating to allow images to be printed on their surfaces. The roll R is formed by winding the label paper M on the core material 401 in such a direction that the surface of the mount D on which the labels L are stuck is directed inward. The mount D from which the labels L have been peeled off is wound around a core material 402 and then collected in the housing 1. The labels L peeled off from the mount D after printing are discharged out of the housing 1 through the discharge port 2. In the present embodiment, the width of the label paper M that is adapted to the roll R usable in the printer 100 is 4 inches, 3 inches, 2 inches, 1 inch, and the like.

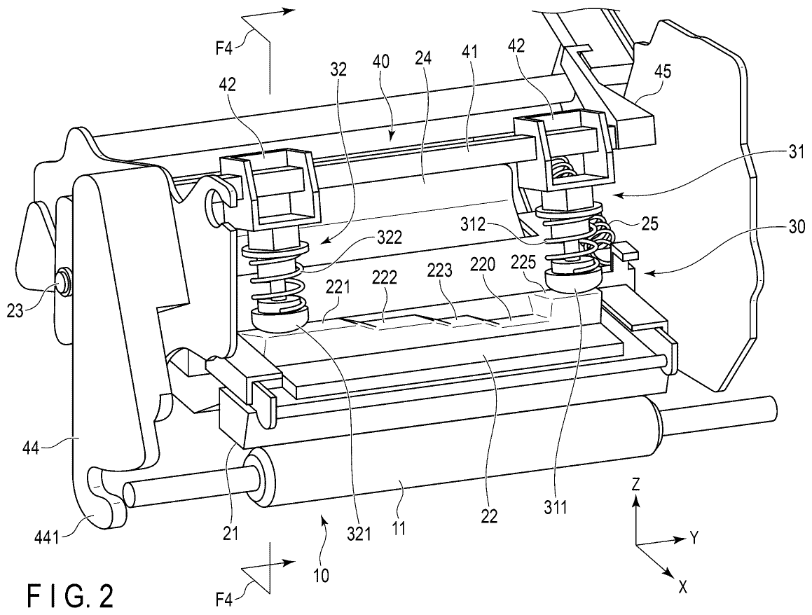

The housing 1 of the printer 100 includes a conveying unit 10, a printing unit 20, a pressing unit 30, a supporting unit 40 and a setting unit 50. The conveying unit 10 draws the label paper M from the roll R and conveys it on a right side basis through a conveying path T. The printing unit 20 prints an image on each of the labels L of the label paper M. The pressing unit 30 presses a pressed block 22 (FIG. 2) of the printing unit 20 toward a platen roller 11 at a plurality of positions in the Y direction. The supporting unit 40 supports two pressing members 31 and 32 (FIG. 2) of the pressing unit 30 so as to be movable in the Y direction. The setting unit 50 sets the pressure corresponding to the positions of the two pressing members 31 and 32 which have moved in the Y direction in accordance with the width of the label paper M, as will be described later.

As shown in FIGS. 1 and 2, the platen roller 11 is included in the conveying unit 10 and has a rotating shaft extending in the Y direction. The platen roller 11 is located slightly below the discharge port 2 and is shifted forward from the center of the housing 1 in its longitudinal direction. The platen roller 11 has a length in the Y direction that exceeds the width of the label paper M whose maximum width is 4 inches. Both ends of the rotating shaft of the platen roller 11 are rotatably attached to the housing 1. The platen roller 11 is located alongside the back surface of the mount D of the label paper M that is conveyed through the conveying path T. That is, the platen roller 11 is close to the underside of the conveying path T for the label paper M. The platen roller 11 rotates clockwise in FIG. 1.

The conveying unit 10 includes, in addition to the platen roller 11, two guide rollers 12 and 13, a winding shaft 14 on which the core material 402 is attached to wind the mount D from which the labels L have been peeled off, and a motor (not shown) that rotates the platen roller 11 and the winding shaft 14. The conveying path T for the label paper M conveyed by the conveying unit 10 starts at a point where the label paper M is drawn out of the roll R and ends at a point where the label paper M is wound by the core material 402 attached to the winding shaft 14 through the guide roller 12, thermal head 21 (platen roller 11) and guide roller 13. Between the guide roller 12 and thermal head 21 which are located back in the housing 1, the conveying path T extends substantially horizontally toward the discharge port 2 along the XY plane.

The thermal head 21 is included in the printing unit 20. The pressing unit 30 presses the block 22 of the printing unit 20 toward the platen roller 11 and thus presses the thermal head 21 on the platen roller 11. The thermal head 21 is located above the platen roller 11 with the conveying path T for the label paper M interposed therebetween. The thermal head 21 has a length exceeding the maximum width of the label paper M along the Y direction. The platen roller 11 and the thermal head 21 have substantially the same length. The label paper M drawn out of the roll R passes through the conveying path T between the platen roller 11 and the thermal head 21. The thermal head 21 is located alongside the labels L of the label paper M.

Since the thermal head 21 is pressed on the platen roller 11 of the conveying unit 10 by the pressing unit 30, if the platen roller 11 is rotated in this state, it gives a conveying force to the label paper M that passes between the thermal head 21 and the platen roller 11. As the platen roller 11 rotates clockwise in FIG. 1, the label paper M is drawn out of the roll R and the roll R rotates counterclockwise as shown in FIG. 1.

The printing unit 20 includes a swinging frame 24 that is swingably attached to the housing 1 about a shaft 23 extending in the Y direction. The shaft 23 is substantially at the center of the housing 1 in the back-and-forth direction, and the swinging frame 24 extends forward from the shaft 23. The swinging frame 24 fixes the thermal head 21 to the lower surface side of the tip of the swinging. The swinging frame 24 also fixes the pressed block 22 at a position opposed to the thermal head 21 on the upper surface side of the tip of the swinging. As shown in FIG. 1, the pressed block 22 may be provided integrally with the swinging frame 24 or integrally with the thermal head 21.

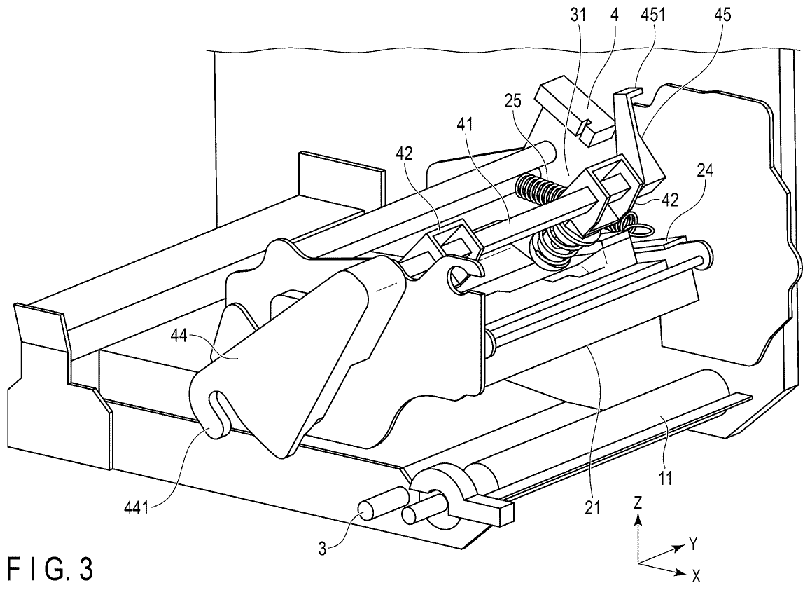

The thermal head 21 includes h a plurality of heating elements that are arranged in the Y direction across the conveying path T for the label paper M. The thermal head 21 can be located at the printing position shown in FIGS. 1 and 2 where it is pressed on the platen roller 11 with the conveying path T interposed therebetween. The thermal head 21 can also be located at the retracted position shown in FIG. 3, which is separated from the platen roller 11 by rotating the swinging frame 24 counterclockwise in FIG. 1 from the printing position. While the thermal head 21 is located at the printing position, it is energized through the heating elements in response to image signals to print images on the labels L of the label paper M conveyed through the conveying path T.

The printing unit 20 includes a tension spring 25 one end of which is fixed to the housing 1. The other end of the tension spring 25 is fixed to the swinging frame 24 at a position separated from the shaft 23. When the thermal head 21 is located at the printing position, the tension spring 25 is stretched. The tension spring 25 urges the swinging frame 24 counterclockwise in FIG. 1 by its restoring force to move the thermal head 21 to the retracted position.

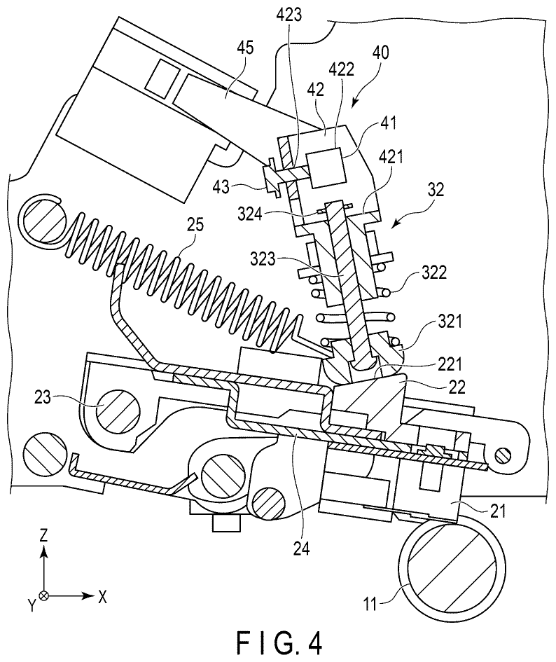

As shown in FIGS. 2 to 4, the pressed block 22 has on its surface four pressure-receiving surfaces 221, 222, 223 and 225 which can be pressed by the two pressing members 31 and 32 of the pressing unit 30 and one non-contact surface 220 with which the pressing member 32 is not in contact, while the thermal head 21 is located at the printing position described above. FIG. 4 is a sectional view of the structure of FIG. 2 taken along line F4-F4, showing a state in which the left-side pressing member 32 is pressed on the left-most pressure-receiving surface 221.

The four pressure-receiving surfaces 221, 222, 223 and 225 and one non-contact surface 220 are arranged in the Y-direction in the order presented in the figure, and are provided on the upper surface of the pressed block 22 away from the thermal head 21. That is, the non-contact surface 220 is located between the rightmost pressure-receiving surface 225 and the pressure-receiving surface 223, which arranged left side of the rightmost pressure-receiving surface 225. The four pressure-receiving surfaces 221, 222, 223 and 225 are planes that are substantially orthogonal to the direction in which the thermal head 21 is pressed on the platen roller 11 while the thermal head 21 is located at the pressing position.

The distances from the four pressure-receiving surfaces 221, 222, 223 and 225 and the slide rail 41 of the supporting unit 40, which will be described later, are different. The four pressure-receiving surfaces 221, 222, 223 and 225 also function as components of the setting unit 50, which will be described later, to set the pressure made by the pressing member 32 to a desired value. The four pressure-receiving surfaces 221, 222, 223 and 225 and one non-contact surface 220 will be described in detail later.

The pressing unit 30 includes a pressing member 31 that is fixed to the right side of the conveying path T so as to face the rightmost pressure-receiving surface 225 of the pressed block 22 and a pressing member 32 that is movable to a position opposed to the pressure-receiving surfaces 221, 222 and 223 and non-contact surface 220. The two pressing members 31 and 32 can be located at desired positions in the Y direction along the slide rail 41 of the supporting unit 40.

In the present embodiment, the right pressing member 31 is fixed at a position where it presses the rightmost pressure-receiving surface 225 in order to convey four sheets of label paper M having different widths with the right end of the conveying path T as a reference (side reference). The left pressing member 32 is located at a position where it presses any of the remaining three pressure-receiving surfaces 221, 222 and 223 or at a position opposed to the non-contact surface 220 according to the width of the label paper M. Since the two pressing members 31 and 32 have the same structure, the left pressing member 32 will be described here, and a detailed description of the right pressing member 31 will be omitted.

As shown in FIG. 4, the pressing member 32 includes a presser 321 capable of pressing the pressure-receiving surfaces 221, 222 and 223, a compression coil spring 322 (elastic member) and a shaft 323 inserted into the compression coil spring 322. The compression coil spring 322 has a distal end fixed to the presser 321 and a proximal end fixed to the slider 42 of the support unit 40, to press the presser 321 on the pressure-receiving surfaces 221, 222 and 223 by a restoring force based on the compression. As the elastic member that generates the restoring force based on the compression, a leaf spring or the like may be used in place of the compression coil spring 322. One end of the shaft 323 that projects from the proximal end of the compression coil spring 322 is attached to the slider 42 movably in the axial direction. The presser 321 is attached axially movably to the other end of the shaft 323.

The pressing member 32 includes a stopper 324 fixed to one end of the shaft 323 in order to prevent the one end of the shaft 323 from coming out of the slider 42 in its axial direction. The compression coil spring 322 is slightly compressed while the stopper 324 fixed to the one end of the shaft 323 abuts on the surface 421 of the slider 42, the presser 321 is located at the farthest other end of the shaft 323, and the presser 321 is not pressed. If, in this state, the presser 321 is pressed on the pressure-receiving surface 221, the one end of the shaft 323 slides toward the slide rail 41 with respect to the slider 42, the stopper 324 is separated from the surface 421, and the compression coil spring 322 is compressed, with the result that pressure based on the restoring force of the compression coil spring 322 acts on the pressure-receiving surface 221.

As described above, the supporting unit 40 includes two sliders 42 to which the proximal ends of the two pressing members 31 and 32 are attached and a slide rail 41 to which the two sliders 42 are attached movably in the Y direction. The slide rail 41 is, for example, a pipe whose section is rectangular, and can be inserted into a rectangular hole 422 of the slider 42 so as not to rotate. The supporting unit 40 has a fixing screw 43 (fixing unit) to fix the slider 42 to the slide rail 41. The slider 42 has a screw hole 423 into which the fixing screw 43 is screwed, and the tip of the fixing screw 43 is pressed on the outer surface of the slide rail 41 the slider 42. Thus, the slider 42 can be fixed to the slide rail 41.

When the slide rail 41 is rotated about its imaginary central axis (axis extending in the Y direction through the center of gravity of the rectangular section), the slider 42 can be rotated, and the pressing members 31 and 32 each having a proximal end attached to the slider 42 can be rotated. In this case, the pressing members 31 and 32 rotate in a direction along a plane parallel to the XZ plane. Both ends of the slide rail 41 in its Y direction are rotatably supported by the housing 1. As shown in FIG. 3, the rotating proximal end of an operation lever 44 is fixed to the left end of the slide rail 41. The rotating proximal end of a hook 45 having an engaging claw 451 at its tip is fixed to the right end of the slide rail 41.

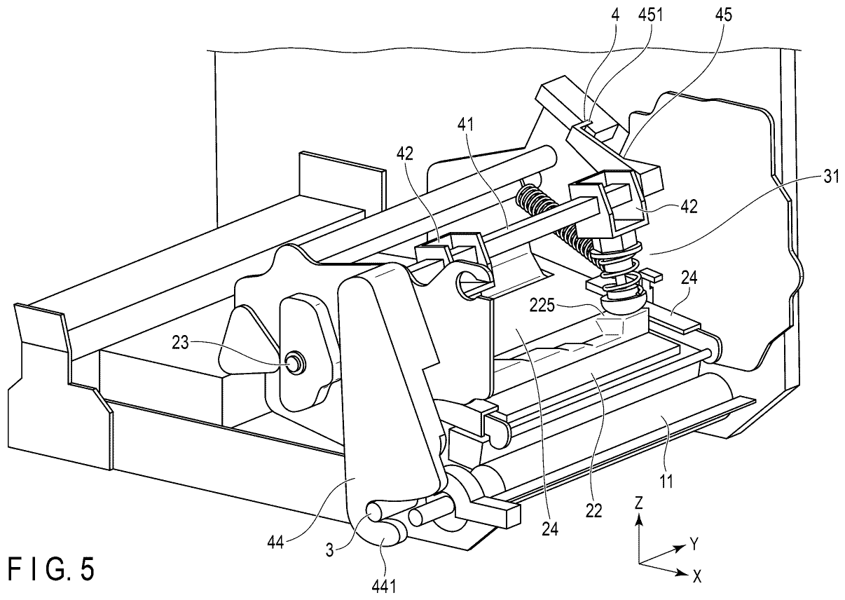

If, therefore, the operation lever 44 is rotated counterclockwise as shown in FIG. 3 from the state in which the thermal head 21 is located in the retracted position, the two pressing members 31 and 32 having the proximal end attached to the slide rail 41 are rotated from the position shown in FIG. 3 to the positions shown in FIGS. 4 and 5. If the two pressing members 31 and 32 are rotated in the direction from the retreating position of the thermal head 21 toward the pressing position thereof, a presser 311 presses the pressure-receiving surface 225 of the pressed block 22, and the presser 321 presses the pressure-receiving surface 221. Thus, the thermal head 21 of the printing unit 20 is pressed on the platen roller 11.

If the two pressing members 31 and 32 are rotated to their pressing positions, a hook 441 at the rotation tip of the operation lever 44 provided at the left end of the slide rail 41 is engaged with a pin 3 projected in the-Y direction from the housing 1, and the engaging claw 451 of the hook 45 provided at the right end of the slide rail 41 is fit into a groove 4 formed in the housing 1. Thus, the thermal head 21 can easily be positioned relative to the housing 1 (platen roller 11) by the operation lever 44 and the hook 45, and the pressure applied by the two pressing members 31 and 32 can easily be controller. In addition, the rotation of the slide rail 41 can be stopped by the operation lever 44 and the hook 45 while the two pressing members 31 and 32 are located at the pressing position where the thermal head 21 is pressed on the platen roller 11, and the two pressing members 31 and 32 can be fixed at the pressing position. The fixing of the two pressing members 31 and 32 to the pressing position can easily be released by rotating the operation lever 44 clockwise in FIG. 5.

While the two pressing members 31 and 32 are located in the retracted position shown in FIG. 3, the pressers 311 and 321 are separated from the pressure-receiving surfaces 221 and 225. Thus, no pressure acts on the pressed block 22 in the direction toward the platen roller 11. Therefore, the swinging frame 24 of the printing unit 20 is urged counterclockwise in FIG. 3 by the restoring force of the tension spring 25, and the thermal head 21 is located at the retracted position.

If the operation lever 44 is rotated counterclockwise from the above state, the two pressing members 31 and 32 swing toward the pressing position, and the pressers 311 and 321 slide on the upper surface of the swing frame 24 and abut against the pressure-receiving surfaces 221 and 225. At this time, the compression coil springs 312 and 322 are compressed and contracted according to the distance between each of the pressure-receiving surfaces 221 and 225 and the slide rail 41, and a predetermined pressure acts on the pressure-receiving surfaces 211 and 225.

The setting unit 50 sets the pressure corresponding to the positions of the two pressing members 31 and 32 in their Y direction. The pressure applied to the pressed block 22 by the pressing members 31 and 32 can be set to a desired value by adjusting the distance from the slide rail 41 to the pressure-receiving surface of the pressed block 22. In the present embodiment, the pressing force for pressing the pressure-receiving surfaces 221 and 225 is set to be the largest, the pressing force for pressing the pressure-receiving surface 222 is set to be smaller than it, the pressing force for pressing the pressure-receiving surface 223 is set to be much smaller, and the pressing force for pressing the non-contact surface 220 (not actually pressed) is set to 0.

As shown in FIG. 2, the distance between the pressure-receiving surface 221 located on the leftmost side in the Y direction and the slide rail 41 to which the proximal ends of the pressing members 31 and 32 are attached is the shortest, and the amount of compression of the compression coil spring 322 is the largest while the presser 321 of the left-side pressing member 32 is pressed on the pressure-receiving surface 221. As the amount of compression of the compressed coil spring 322 increases, the restoring force thereof can be increased. Thus, the pressing force for pressing the pressure-receiving surface 221 by the presser 321 of the pressing member 32 is the largest compared with the pressing force for pressing the other pressure-receiving surfaces 222 and 223.

The pressure-receiving surface 225 on the rightmost side in the Y direction is a surface assigned to the right-side pressing member 31, and the presser 311 of the right-side pressing member 31 is pressed on the pressure-receiving surface 225. The pressure-receiving surface 225 is located on the same plane as the leftmost pressure-receiving surface 221, and the distance between the pressure-receiving surface 225 and the slide rail 41 is set to the same value as the distance between the pressure-receiving surface 221 and the slide rail 41. Therefore, while the presser 311 of the right-side pressing member 31 is pressed on the pressure-receiving surface 225, the amount of compression of the compression coil spring 312 of the pressing member 31 is equal to that of the compression coil spring 322, and the pressing force for pressing the pressure-receiving surface 225 is equal to that for pressing the pressure-receiving surface 221.

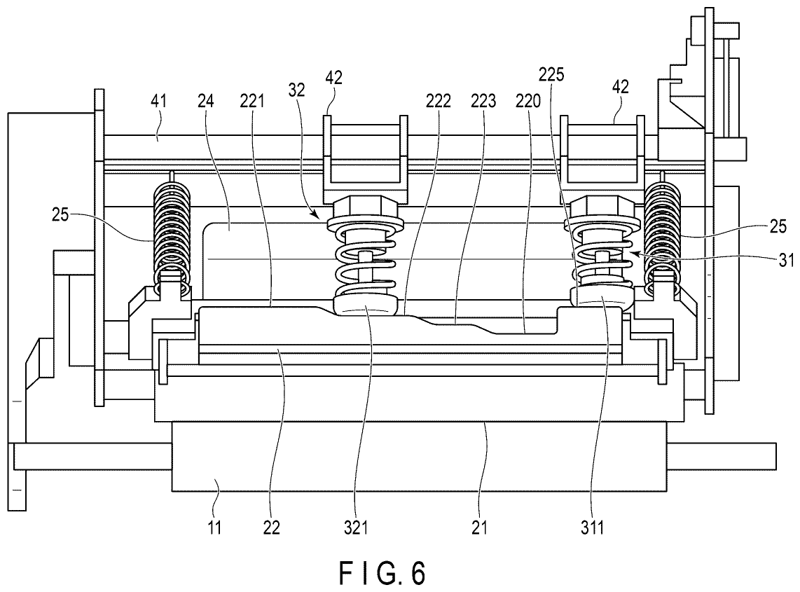

There is a step between the second pressure-receiving surface 222 from the left and the pressure-receiving surface 221. The pressure-receiving surface 222 is located at a position where the distance between the pressure-receiving surface 222 and the slide rail 41 is slightly greater than the distance between the pressure-receiving surface 221 and the slide rail 41. Thus, as shown in FIG. 6, while the presser 321 of the left-side pressing member 32 is pressed on the pressure-receiving surface 222, the amount of compression of the compression coil spring 322 is smaller than while the presser 321 is pressed on the pressure-receiving surface 221 (in the case of FIG. 2). Therefore, the pressing force for pressing the presser 321 of the pressing member 32 on the pressure-receiving surface 222 is smaller than the pressing force for pressing it on the pressure-receiving surfaces 221 and 225.

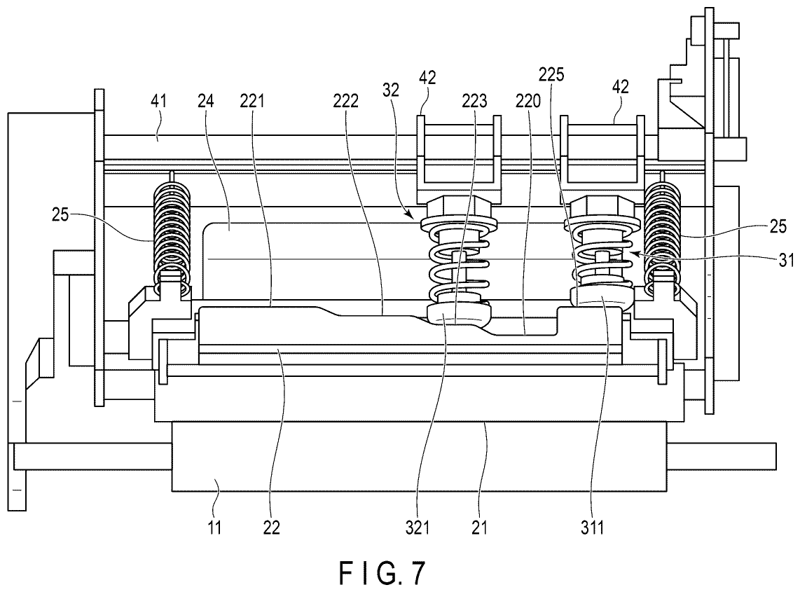

There is a step between the third pressure-receiving surface 223 from the left and the pressure-receiving surface 222. The pressure-receiving surface 223 is located at a position where the distance between the pressure-receiving surface 223 and the slide rail 41 is slightly longer than the distance between the pressure-receiving surface 222 and the slide rail 41. Thus, as shown in FIG. 7, while the presser 321 of the left-side pressing member 32 is pressed on the pressure-receiving surface 223, the amount of compression of the compression coil spring 322 is smaller than while the presser 321 is pressed on the pressure-receiving surface 222. Therefore, the pressing force for pressing the presser 321 of the pressing member 32 on the pressure-receiving surface 223 is smaller than the pressing force for pressing it on the pressure-receiving surface 222.

If a step is provided on each of the four pressure-receiving surfaces 221, 222, 223 and 224 as described above, the pressing force for pressing the pressed block 22 by the pressing members 31 and 32 can be set to a desired value in accordance with the pressing position in the Y direction. In this case, the pressure applied by the pressing members 31 and 32 can be set to a desired value by adjusting the distance between each of the pressure-receiving surfaces 221, 222, 223 and 224 and the slide rail 41.

As described above, the printer 100 of the present embodiment is capable of using four kinds of roll R wound with sheets of label paper M having different widths in the Y direction. In the present embodiment, therefore, the label paper M is conveyed with the right end of the conveying path T as a reference (side reference), and the position of the left-side pressing member 32 in the Y direction is adjusted according to the width of the label paper M. The position of the pressing member 32 is adjusted by moving the pressing member 32 along the slide rail 41 by manual operation of an operator. The pressing member 31 for pressing the pressed block 22 near the right end of the label paper M serving as a conveyance reference is fixed at a position where the rightmost pressure-receiving surface 225 is pressed.

For example, when the label paper M having the maximum width (4-inch width) is inserted into the printer 100, the right-side pressing member 31 is located at a position where the rightmost pressure-receiving surface 225 is pressed and the left-side pressing member 32 is located at a position where the leftmost pressure receiving-surface 221 is pressed, as shown in FIG. 2. The positions and widths of the right and left pressure-receiving surfaces 221 and 225 in the Y direction are set such that the positions where the pressing members 31 and 32 press the two pressure-receiving surfaces 221 and 225 in the Y direction is substantially the same as the width of the label paper M having the maximum width. Therefore, according to the present embodiment, the pressing force for pressing the thermal head 21 on the label paper M having the maximum width can be set to a uniform and desired value along the Y direction, with the result that high-quality printing can be performed on the label paper M having the maximum width.

When the label paper M having a 3-inch width is inserted into the printer 100, the right-side pressing member 31 is located at a position where the rightmost pressure-receiving surface 225 is pressed and the left-side pressing member 32 is located at a position where the second pressure-receiving surface 222 from the left is pressed, as shown in FIG. 6. The positions and widths of the two pressure-receiving surfaces 222 and 225 in the Y direction are set such that the distance between the positions where the pressing members 31 and 32 press the two pressure-receiving surfaces 222 and 225 in the Y direction is substantially the same as the width of the label paper M having a 3-inch width.

In this case, the pressing force for pressing the pressure-receiving surface 222 by the left-side pressing member 32 is smaller than the pressing force for pressing the pressure-receiving surface 225 by the right-side pressing member 31, and the sum of the pressing forces for pressing the pressed block 22 by the two pressing members 31 and 32 is smaller than in the case of FIG. 2. Considering the label paper M as a reference, the pressing force acting per unit width of the label paper M can be made constant by changing the position and pressing force for pressing the pressed block 22 in the Y direction in accordance with the width of the label paper M. In addition, the thermal head 21 can hardly be brought into contact with the platen roller 11 at a position where the label paper M does not exist in the width direction, and high-quality printing can be performed on the label paper M having a 3-inch width.

Similarly, when the label paper M having a 2-inch width is inserted into the printer 100, the right-side pressing member 31 is located at a position where the rightmost pressure-receiving surface 225 is pressed and the left-side pressing member 32 is located at a position where the third pressure-receiving surface 223 from the left is pressed, as shown in FIG. 7. The positions and widths of the two pressure-receiving surfaces 223 and 225 in the Y direction are set such that the distance between the positions where the pressing members 31 and 32 press the two pressure-receiving surfaces 223 and 225 in the Y direction is substantially the same as the width of the label paper M having a 2-inch width.

In this case, the pressing force for pressing the pressure-receiving surface 223 by the left-side pressing member 32 is much smaller than the pressing force for pressing the pressure-receiving surface 222, and the sum of the pressing forces for pressing the pressed block 22 by the two pressing members 31 and 32 is much smaller than in the case of FIG. 6. Considering the label paper M as a reference, the pressing force acting per unit width of the label paper M can be made constant by changing the position and pressing force for pressing the pressed block 22 in the Y direction in accordance with the width of the label paper M. In addition, the thermal head 21 can hardly be brought into contact with the platen roller 11 at a position where the label paper M does not exist in the width direction, and high-quality printing can be performed on the label paper M having a 2-inch width.

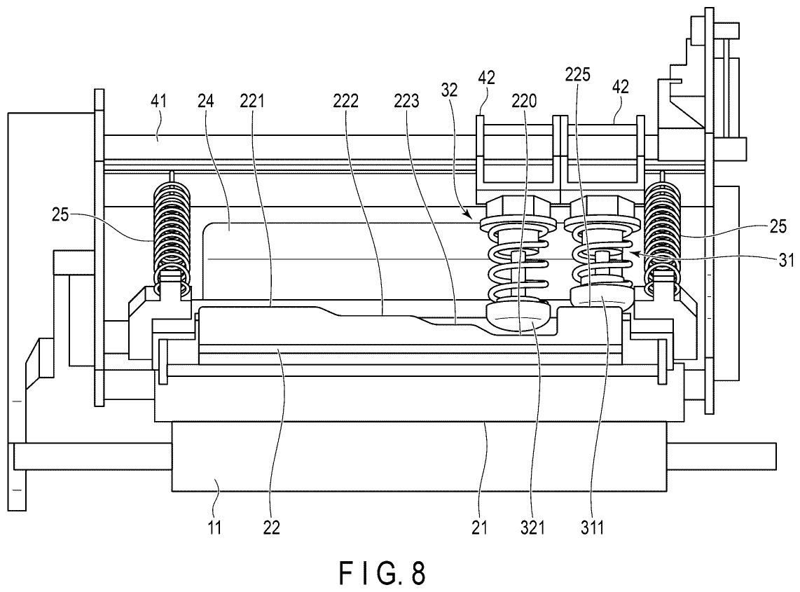

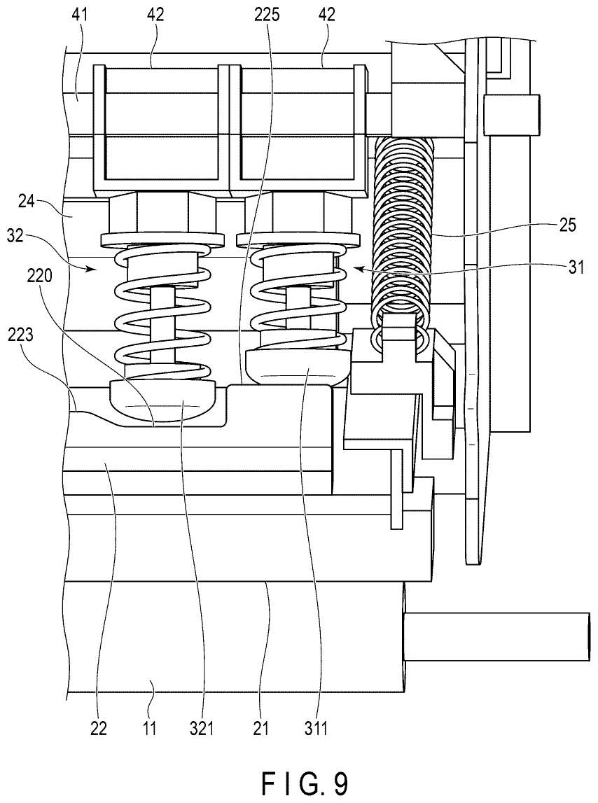

In contrast, when the label paper M having a 1-inch width is inserted into the printer 100, the center of the label paper M in its width direction and the pressing position of the pressure-receiving surface 225 pressed by the right-side pressing member 31 are close to each other. If, therefore, the pressing force applied by the left-side pressing member 32 acts on the pressed block 22, the pressing force acting on the label paper M from the thermal head 21 becomes excessively large. In the present embodiment, therefore, when the label paper M having the minimum width of 1 inch is used, the left-side pressing member 32 is located at a position opposed to the non-contact surface 220 of the pressed block 22 as shown in FIGS. 8 and 9, so that the presser 321 of the pressing member 32 comes into non-contact with the non-contact surface 220.

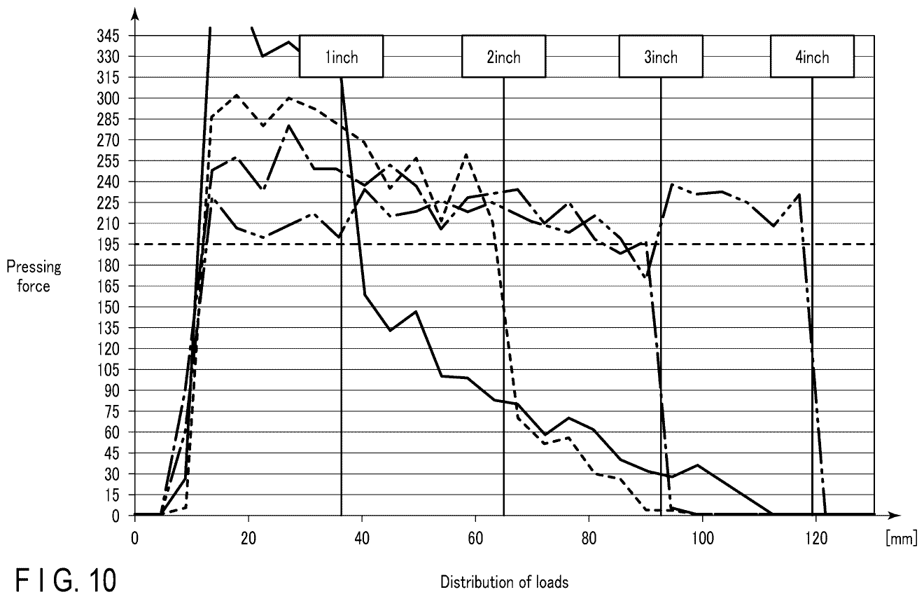

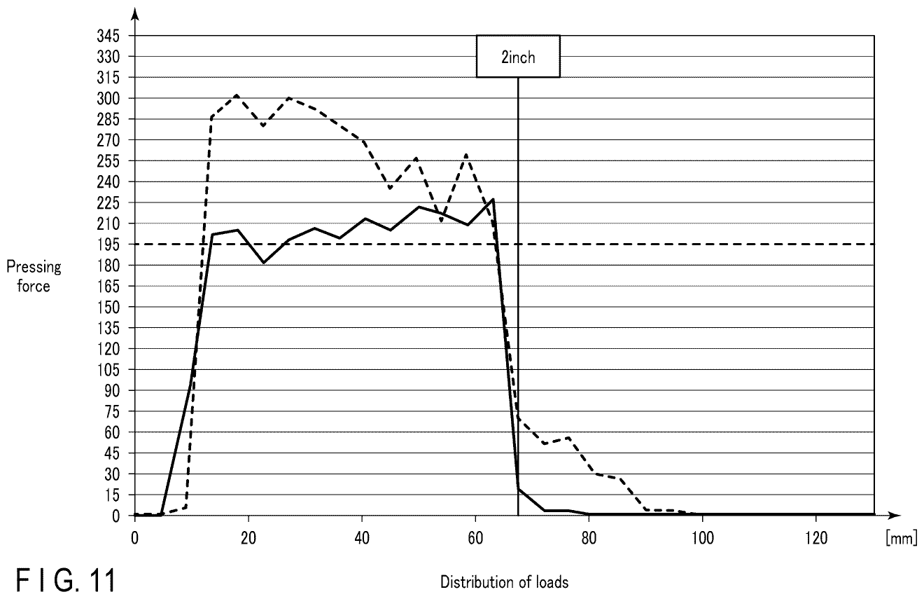

FIG. 10 shows the distribution of loads of pressing force acting on the label paper M in the width direction in respective cases where the two pressing members 31 and 32 are located at the above-described positions according to the width of the label paper M. FIG. 11 shows the distribution of loads of pressing force acting on the label paper M having a 2-inch width among the distribution of loads shown in FIG. 10. In FIGS. 10 and 11, the broken line indicates the target value (195) of the pressing force acting on the label paper M of all widths.

As shown in FIGS. 10 and 11, if the positions of the pressing members 31 and 32 in the Y direction are changed in accordance with the width of the label paper M to set the pressing force acting on the pressed block 22, the pressing force acting on the label paper M of all widths can be made substantially constant in the width direction and can be made close to the target value, the pressing force per unit width acting on the label paper M of different widths can be made substantially the same, and the undesirable pressing force acting on the label paper M of all widths at the position where the label paper M does not exist can be substantially eliminated.

As described above, according to the present embodiment, even if a plurality of kinds of label paper M having different widths is inserted into the printer 100, the pressing force for pressing the thermal head 21 on the label paper M can be made constant in the width direction, the pressing force per unit width can be made substantially constant regardless of the width of the label paper M, and thus the trouble that the thermal head 21 comes into contact with the platen roller 11 at the position where the label paper M does not exist can be suppressed. Therefore, according to the present embodiment, high-quality printing can be performed regardless of the width of the label paper M.

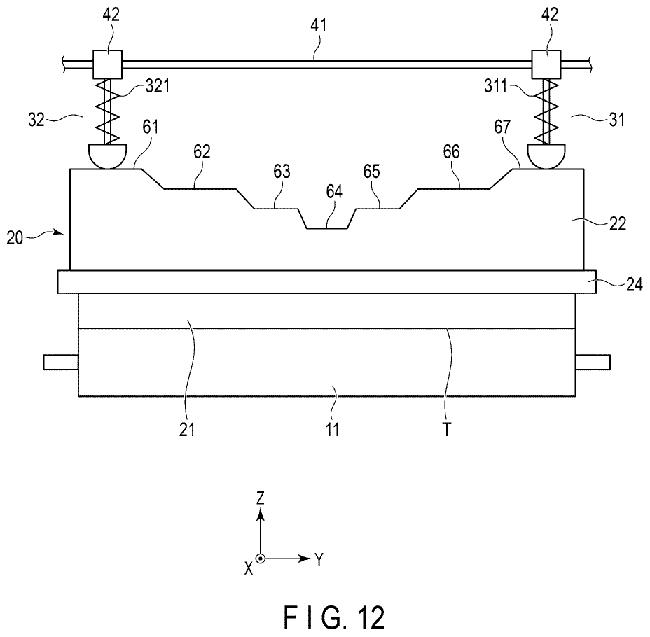

FIG. 12 shows an essential part of a printer according to a modification. The configurations of the printer having the same function as those of the printer 100 of the embodiment are denoted by the same reference symbol, and their detailed descriptions will be omitted.

The printer according to the modification differs from the printer 100 according to the foregoing embodiment in that the label paper M is conveyed on a center basis. The center basis means that regardless of the width of the label paper M, the label paper M is conveyed with the center of the label paper M in the width direction on that of the conveying path T in the width direction.

Like the printer 100 of the above-described embodiment, the printer of the modification has only to provide a plurality of pressing members 31 and 32 that are movable in the Y direction and a plurality of pressure-receiving surfaces 61 to 67 that are arranged in a V shape in the Y direction on the pressed block 22 of the printing unit 20 in order to convey a plurality of kinds of label paper M having different widths on a center basis and thus achieve high-quality printing.

When the label paper M having the maximum width (4-inch width), for example is conveyed, the pressing member 32 is opposed to the leftmost pressure-receiving surface 61, the pressing member 31 is opposed to the rightmost pressure-receiving surface 67, and the two pressure-receiving surfaces 61 and 67 are pressed toward the platen roller 11 with the same pressing force. Since the pressure-receiving surfaces 61 and 67 are closer to the slide rail 41 than the other pressure-receiving surfaces 62 to 66, the amount of compression of the compression coil springs 312 and 322 is maximized and accordingly the pressing force acting on the label paper M having a 4-inch width is increased.

Similarly, when the sheets of label paper M having a 3-inch width, a 2-inch width and 1-inch width are set, the two pressing members 31 and 32 are moved gradually toward the conveyance center, the amount of compression of the compression coil springs 312 and 322 is decreased gradually in accordance with the width of the label sheet M, and the pressing force acting on the label paper M is gradually decreased. When the label paper M having a 1-inch width is conveyed, one of the pressing members 31 and 32 has only to be opposed to the pressure-receiving surface 64, and the other has only to be in non-contact with the pressed block 22.

Like in the printer 100 of the foregoing embodiment, in the printer of the modification, as described above, the pressing force for pressing the thermal head 21 on a plurality of kinds of label paper M having different widths can be made constant, the pressing force per unit width can be made substantially constant regardless of the width of the label paper M, and thus the trouble that the thermal head 21 comes into contact with the platen roller 11 at the position where the label paper M does not exist can be suppressed. Therefore, in the modification, too, high quality printing can be performed regardless of the width of the label paper M.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a conveying unit including a platen roller extending in a first direction across a conveying path of a medium to be printed with an image to convey the medium to be printed in a second direction orthogonal to the first direction through the conveying path;
a printing unit located opposite to the platen roller with the conveying path interposed therebetween to print an image on the medium to be printed conveyed through the conveying path;
a pressing unit which presses the printing unit in a third direction toward the platen roller;
a supporting unit which supports the pressing unit movably in the first direction in accordance with a width of the medium to be printed along the first direction; and
a setting unit which sets a pressing force applied by the pressing unit in accordance with a position of the pressing unit in the first direction such that a pressing force applied to the medium to be printed by the platen roller and the printing unit is uniformed along the first direction and a pressing force per unit length along the first direction is made constant regardless of the width of the medium to be printed.

2. The printer of claim 1, wherein:
the pressing unit includes a presser which presses the printing unit and an elastic member which presses the presser on the printing unit by a restoring force based on compression in the third direction; and
the setting unit adjusts an amount of compression of the elastic member to set a pressing force for pressing the printing unit.

3. The printer of claim 2, wherein the elastic member is a compression coil spring having a proximal end supported by the supporting unit and a distal end to which the presser is attached.

4. The printer of claim 3, wherein the setting unit has a plurality of pressure-receiving surfaces on which the presser is allowed to be pressed, the pressure-receiving surfaces being arranged on the printing unit in the first direction at different distances from the supporting unit in accordance with the amount of compression.

5. The printer of claim 4, wherein the printing unit has one non-contact surface along the first direction as well as the pressure-receiving surfaces at a position where the presser attached to the distal end of the compression coil spring whose compression amount is set to zero is separated from the supporting unit by a distance at which the presser is in a non-contact state.

6. The printer of claim 2, wherein:
the supporting unit includes a slide rail extending in the first direction and a slider which is attached to the slide rail and movable along the slide rail in the first direction; and
the pressing unit includes a compression coil spring having a proximal end fixed to the slider and a distal end to which the presser is fixed, and a shaft having one end inserted into the compression coil spring and movably attached to the slider in the third direction and the other end to which the presser is attached.

7. The printer of claim 6, wherein the supporting unit includes a fixing unit which fixes the slider to the slide rail.

8. The printer of claim 6, wherein the pressing unit includes a stopper fixed to the one end of the shaft to prevent the one end of the shaft from coming out of the slider in the third direction.

9. The printer of claim 6, wherein the presser is movably attached to the other end of the shaft in the third direction.

10. A printer comprising:
a conveying unit including a platen roller extending in a first direction across a conveying path of a medium to be printed with an image to convey the medium to be printed in a second direction orthogonal to the first direction through the conveying path;
a printing unit extending in the first direction opposite to the platen roller with the conveying path interposed therebetween to print an image on the medium to be printed conveyed through the conveying path;
a pressing unit including a plurality of pressing members which press the printing unit in a third direction toward the platen roller at a plurality of positions in the first direction;
a supporting unit which supports proximal ends of the pressing members movably in the first direction in accordance with a width of the medium to be printed along the first direction; and
a setting unit which sets a distance from the supporting unit to a plurality of pressure-receiving surfaces of the printing unit such that a pressing force applied to the medium to be printed by the platen roller and the printing unit is uniformed along the first direction and a pressing force per unit length along the first direction is made constant regardless of the width of the medium to be printed in a state that the pressure-receiving surfaces of the printing unit are provided along the first direction and allowed to be pressed in the third direction by distal ends of the pressing members whose proximal ends are supported by the supporting unit, and the pressing members are moved in the first direction in accordance with the width of the medium to be printed.

11. The printer of claim 10, wherein:
the pressing members include a presser which presses the pressure-receiving surfaces and an elastic member which presses the presser on the pressure-receiving surfaces by a restoring force based on compression in the third direction; and
the setting unit sets the distance from the supporting unit to the pressure-receiving surfaces to a predetermined distance, adjusts an amount of compression of the elastic member to a predetermined value, and sets a pressing force for pressing the pressure-receiving surfaces by the presser to a predetermined value.

12. The printer of claim 11, wherein the elastic member is a compression coil spring having a proximal end supported by the supporting unit and a distal end to which the presser is attached.

13. The printer of claim 12, wherein the printing unit has one non-contact surface along the first direction as well as the pressure-receiving surfaces at a position where the presser attached to the distal end of the compression coil spring whose compression amount is set to zero is separated from the supporting unit by a distance at which the presser is in a non-contact state.

14. The printer of claim 11, wherein:
the supporting unit includes a slide rail extending in the first direction and a plurality of sliders which are attached to the slide rail and movable along the slide rail in the first direction; and
the pressing member includes a compression coil spring having a proximal end fixed to the sliders and a distal end to which the presser is attached, and a shaft having one end inserted into the compression coil spring and movably attached to the sliders in the third direction and the other end to which the presser is attached.

15. The printer of claim 14, wherein the supporting unit includes a fixing unit which fixes the sliders to the slide rail.

16. The printer of claim 13, wherein the pressing member includes a stopper fixed to the one end of the shaft to prevent the one end of the shaft from coming out of the sliders in the third direction.

17. The printer of claim 13, wherein the presser is movably attached to the other end of the shaft in the third direction.
